(19) United States
(12) Patent Application Publication
(10) Pub. No.: US 2011/0285639 A1
(43) Pub. Date: Nov. 24, 2011

(54) Computing Device Writing Implement Techniques

(75) Inventors: Jonathan R. Harris, Redmond, WA (US); Andrew S. Allen, Seattle, WA (US); Georg F. Petschnigg, Seattle, WA (US)

(73) Assignee: Microsoft Corporation, Redmond, WA (US)

(21) Appl. No.: 12/784,867

(22) Filed: May 21, 2010

(51) Int. Cl. G06F 3/041

(52) U.S. Cl. 345/173

(57) ABSTRACT

Computing device writing implement techniques are described. In implementations, a user interface is output that includes representations of writing implements, one or more of the representations being associated with characteristics of the corresponding writing implement to be applied to lines detected as being drawn using touchscreen functionality of the computing device; and lines detected as being erased using touchscreen functionality of the computing device. Responsive to a selection of at least one of the representations, the corresponding characteristics are applied to at least one input received via the touchscreen functionality.

### BACKGROUND

The amount of functionality that is available from computing devices is ever increasing, such as from mobile devices, game consoles, televisions, set-top boxes, personal computers, and so on. However, traditional techniques that were employed to interact with the computing devices may become less efficient as the amount of functionality increases. Consequently, the addition of these functions may frustrate users by the sheer number of choices of functions and thereby result in decreased utilization of both the additional functions as well as the device itself that employs the functions.

### SUMMARY

Computing device writing implement techniques are described. In implementations, a user interface is output that includes representations of writing implements, one or more of the representations being associated with characteristics of the corresponding writing implement to be applied to lines detected as being drawn using touchscreen functionality of the computing device; and lines detected as being erased using touchscreen functionality of the computing device. Responsive to a selection of at least one of the representations, the corresponding characteristics are applied to at least one input received via the touchscreen functionality.

In implementations, an input is recognized as indicating initiation of an erase operation. A characteristic is determined of a writing implement selected to interact with the computing device using touchscreen functionality, the characteristic configured to mimic drawing and erasing characteristics of the writing implement. Erasing characteristics of the selected writing implement are applied to one or more lines output by the computing device.

In implementations, one or more computer-readable media comprise instructions that, responsive to execution on a computing device, causes the computing device to perform operations comprising: outputting a user interface including representations of writing implements; receiving a selection of at least one of the representations of the writing implements; recognizing an input as indicating selection of an erase operation via the touchscreen functionality of the computing device, the input provided by a stylus using touchscreen functionality of a display device; determining which erasing characteristics correspond to the selected representation of the writing implement; and applying the determined erasing characteristics of the selected representation of the writing implement to one or more lines output by the computing device associated with a location of the stylus on the display device that was used to provide the input to select the erase operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ writing implement techniques described herein.

FIG. 2 depicts a system in an example implementation in which a user interface is output having representations of writing implements that are selectable to apply corresponding characteristics to inputs received via touchscreen functionality of a computing device of FIG. 1.

FIG. 3 depicts a system in an example implementation in which an erase operation is performed having characteristics that correspond to a representation of a writing implement of a pen chosen through interaction with a user interface of FIG. 2.

FIG. 4 depicts a system in an example implementation in which an erase operation is performed having characteristics that correspond to a representation of a writing implement of a pencil chosen through interaction with the user interface of FIG. 2.

FIG. 5 depicts a system in an example implementation in which another erase operation is performed having characteristics that correspond to a representation of a writing implement of a pencil chosen through interaction with the user interface of FIG. 2.

FIG. 6 is a flow diagram depicting a procedure in an example implementation in which selection of a writing implement is used as a basis to apply characteristics to an erase operation.

FIG. 7 illustrates various components of an example device that can be implemented as any type of portable and/or computer device as described with reference to FIGS. 1-6 to implement embodiments of the writing implement techniques described herein.

### DETAILED DESCRIPTION

Overview

As the amount of functionality that is available from computing devices increases, traditional techniques that were employed to interact with the computing devices may become less efficient. For example, inclusion of additional features using traditional techniques may force the user to navigate “away” from a current user interface to access the functionality. Thus, traditional techniques that were used to access the functions may limit the usefulness of the functions and the device as a whole to a user of the computing device.

Computing device writing implement techniques are described. In implementations, a user interface is output that includes representations of writing implements, such as a pen and pencil. Selection of the writing implement causes corresponding characteristics to be applied to inputs received via touchscreen functionality of the computing device. For example, selection of a pencil may cause a line drawn by the stylus on a display device to mimic a line drawn by an “actual” pencil. Likewise, the selection of a pencil may cause erasing characteristics of the pencil to be mimicked, such as by progressively lightening an area (e.g., lines) that are to be erased through movement of the pencil across the display device. Thus, selection of the writing implement may be leveraged to provide an intuitive experience to user's interaction with the computing device without navigating “away” from a current experience, such as to access a menu to erase or draw lines. Further discussion of writing implement techniques may be found in relation to the following sections.

In the following discussion, an example environment is first described that is operable to employ the techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

Example Environment

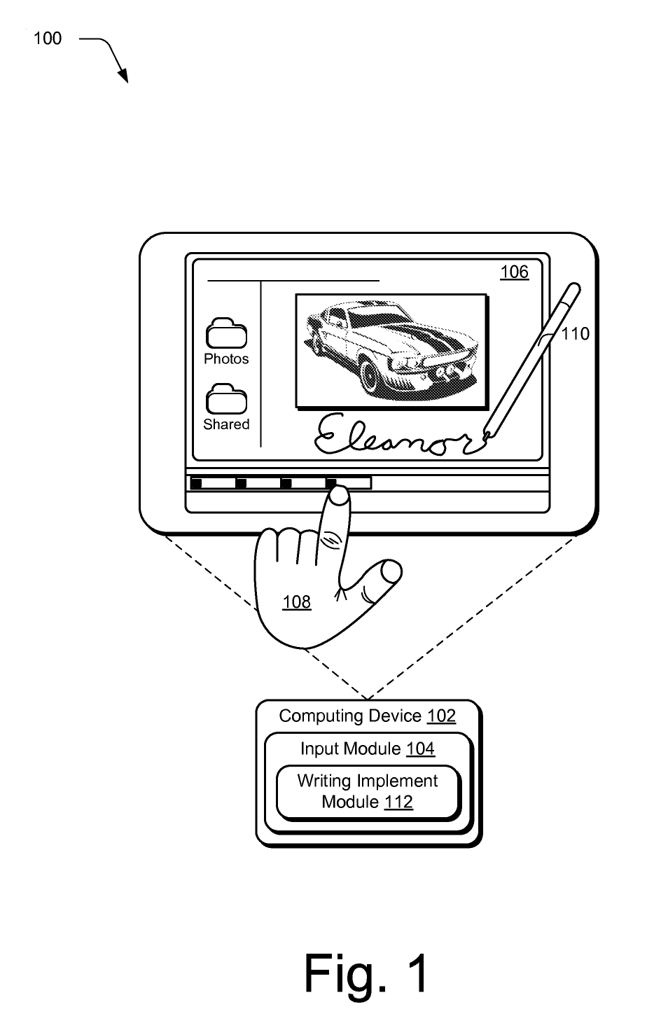

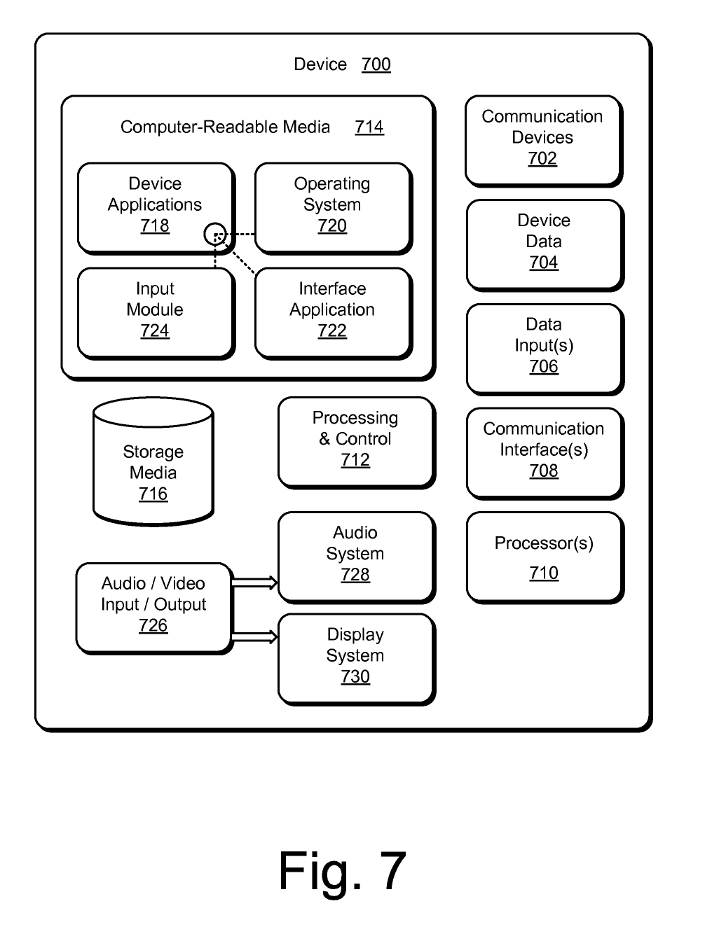

FIG. 1 is an illustration of an environment 100 in an example implementation that is operable to employ writing implement techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 7. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input module 104. The input module 104 is representative of functionality relating to inputs of the computing device 102. For example, the input module 104 may be configured to receive inputs from a keyboard, mouse, to identify gestures and cause operations to be performed that correspond to the gestures, and so on. The inputs may be identified by the input module 104 in a variety of different ways.

For example, the input module 104 may be configured to recognize an input received via touchscreen functionality of a display device 106, such as a finger of a user's hand 108 as proximal to the display device 106 of the computing device 102, from a stylus 110, and so on. The input may take a variety of different forms, such as to recognize movement of the stylus 110 and/or a finger of the user's hand 108 across the display device 106, such as a tap, drawing of a line, and so on. In implementations, these inputs may be recognized as gestures.

A variety of different types of gestures may be recognized, such a gestures that are recognized from a single type of input (e.g., touch gestures) as well as gestures involving multiple types of inputs. For example, the computing device 102 may be configured to detect and differentiate between a touch input (e.g., provided by one or more fingers of the user's hand 108) and a stylus input (e.g., provided by a stylus 110). The differentiation may be performed in a variety of ways, such as by detecting an amount of the display device 108 that is contacted by the finger of the user's hand 108 versus an amount of the display device 106 that is contacted by the stylus 110. Differentiation may also be performed through use of a camera to distinguish a touch input (e.g., holding up one or more fingers) from a stylus input (e.g., holding two fingers together to indicate a point) in a natural user interface (NUI). A variety of other example techniques for distinguishing touch and stylus inputs are contemplated, further discussion of which may be found in relation to FIG. 7.

Thus, the input module 104 may support a variety of different gesture techniques by recognizing and leveraging a division between stylus and touch inputs. For instance, the input module 104 may be configured to recognize the stylus as a writing tool, whereas touch is employed to manipulate objects displayed by the display device 106. However, it should be readily apparent that both touch and stylus inputs may also be leveraged for common functionality, such as to both serve as a basis to input lines that are to be displayed on the display device 106 of the computing device 102.

The computing device 102 is further illustrated as including a writing implement module 112. The writing implement module 112 is representative of functionality of the computing device 102 to employ techniques to mimic use of different writing implements, mimic functionality of a single writing implement, and so on. For example, the writing implement module 112 may be configured to detect inputs provided by the user's hand 108, the stylus 110, and so on and characterize a display of the inputs based on a writing implement that was selected. For instance, selection of a pencil may have corresponding characteristics, such as to draw lines to appear as being drawn by an “actual” pencil, erase an area of the user interface to be progressively lighter to appear as if erased with a rubber eraser, and so on. Further discussion of selection of representations of writing implements and functionality that may be provided based on the selection may be found in relation to the following figures.

Although the following discussion may describe specific examples of touch and stylus inputs, in instances the types of inputs may be switched (e.g., touch may be used to replace stylus and vice versa) and even removed (e.g., both inputs may be provided using touch or a stylus) without departing from the spirit and scope thereof. Further, it should also be apparent that the touchscreen functionality described herein may leverage a variety of technologies relating to interaction with the computing device 102 and do not necessitate actual touch, e.g., the techniques may also leverage use of cameras to capture the inputs.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the writing implement techniques described below are platform-independent, meaning that the techniques may be implemented on a variety of commercial computing platforms having a variety of processors.

Writing Implement Examples

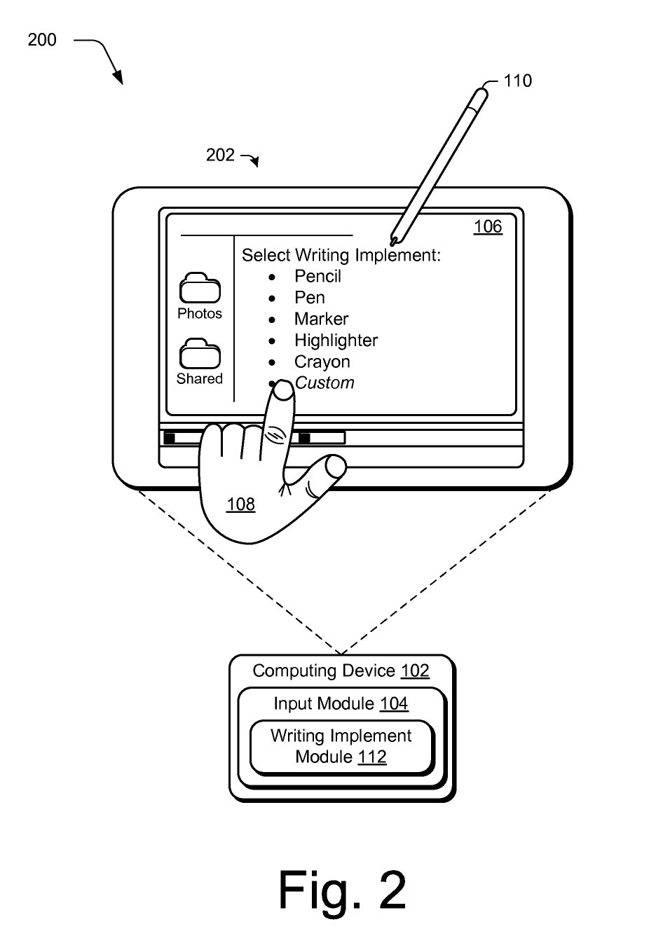

FIG. 2 depicts a system 200 in an example implementation in which a user interface is output having representations of writing implements that are selectable to apply corresponding characteristics to inputs received via touchscreen functionality of the computing device 102 of FIG. 1. The computing device 102 is illustrated as displaying a user interface 202 generated by the writing implement module 112 and displayed by the display device 106. The user interface 202 includes a plurality of representations of writing implements, such as a “pencil,” “pen,” “marker,” “highlighter,” “Crayon,” and “Custom.”

Selection of the representations may be used to configure subsequent inputs received via the touchscreen functionality of the computing device 102. For example, selection of the pen may cause lines that are subsequently drawn (e.g., by a finger of the user's hand 108, the stylus 110, and so on) to appear as if written in ink. Likewise, selection of the representation of the pencil may cause lines that are subsequently drawn (e.g., by a finger of the user's hand 108, the stylus 110, and so on) to appear as if written in pencil. This may include employing shading techniques to darken an area of the user interface in response to repeated movement (e.g., by the stylus 110) over an area of the display device 106. In this way, a user may be provided with a variety of different options with which to interact with the computing device, including customizing this interaction by selecting the “Custom” representation. This mimicking of the writing implement may also be leveraged by an erase operation, an example of which may be found in relation to the following figure.

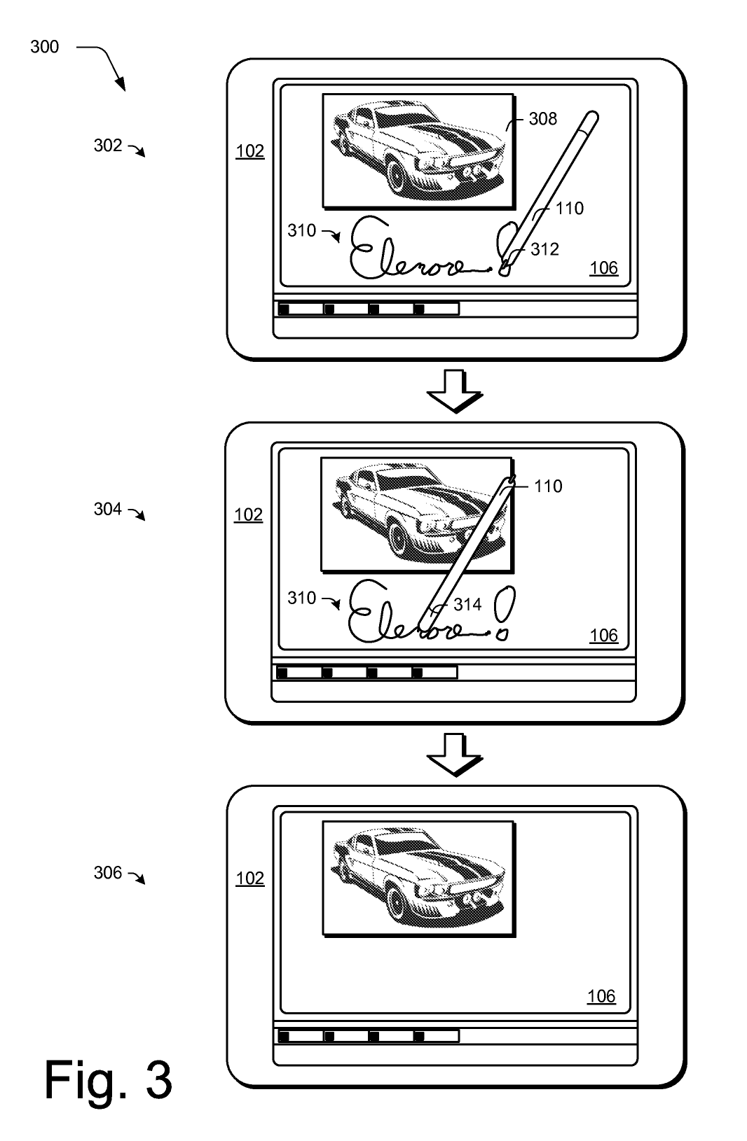

FIG. 3 depicts a system 300 in an example implementation in which an erase operation is performed having characteristics that correspond to a representation of a writing implement of a pen chosen through interaction with the user interface of FIG. 2. The system 300 of FIG. 3 is illustrated as including first, second, and third stages 302, 304, 306.

At the first stage 302, a photo 308 of a car is illustrated as being displayed by the display device 106. A caption is also illustrated as freeform lines 310 that were handwritten using a first end 312 of the stylus 110. Thus, in this example the input module 104 of FIG. 1 is configured to recognize the first end 312 of the stylus 110 is to be used to draw. Additionally, in this example the representation of the writing implement of a “pen” was selected in FIG. 2 and therefore the freeform lines 310 are displayed to mimic strokes of a pen.

At the second stage 304, however, a user may realize that the caption composed of the freeform lines 310 is spelled incorrectly, i.e., this alternate spelling is incorrect in this instance for the type of car. Accordingly, a second end 314 of the stylus 110 may be utilized to indicate that an erase operation is to be performed to erase the freeform lines 310. Because the representation of the pen writing implement was selected, the erase operation is performed to have characteristics in accordance with a pen, which in this case is to delete the freeform lines 310 as a whole, which is illustrated in the third stage 306.

For instance, a user may “tap” and/or move the second end 314 of the stylus 110 over the display of the freeform lines 310 to indicate that the freeform lines 310 are to be deleted. Additionally, logic may be employed to delete related groupings of lines, such as lines input with a threshold amount of time, e.g., with a total predefined time period, having gaps between inputs of the lines that fall within a predefined time period, and so on. In the illustrated example, the cursive line that is used to write “Elenore” is recognized as grouped with the cursive lines used to form the exclamation point.

Thus, in this example the erase operation associated with the representation of the pen causes the freeform lines 310 to be deleted as a whole, thereby clearing the user interface output by the display device 106 for a correct caption of “Eleanor.” A variety of other characteristics of writing implements may also be mimicked, another example of which may be found in relation to the following figure.

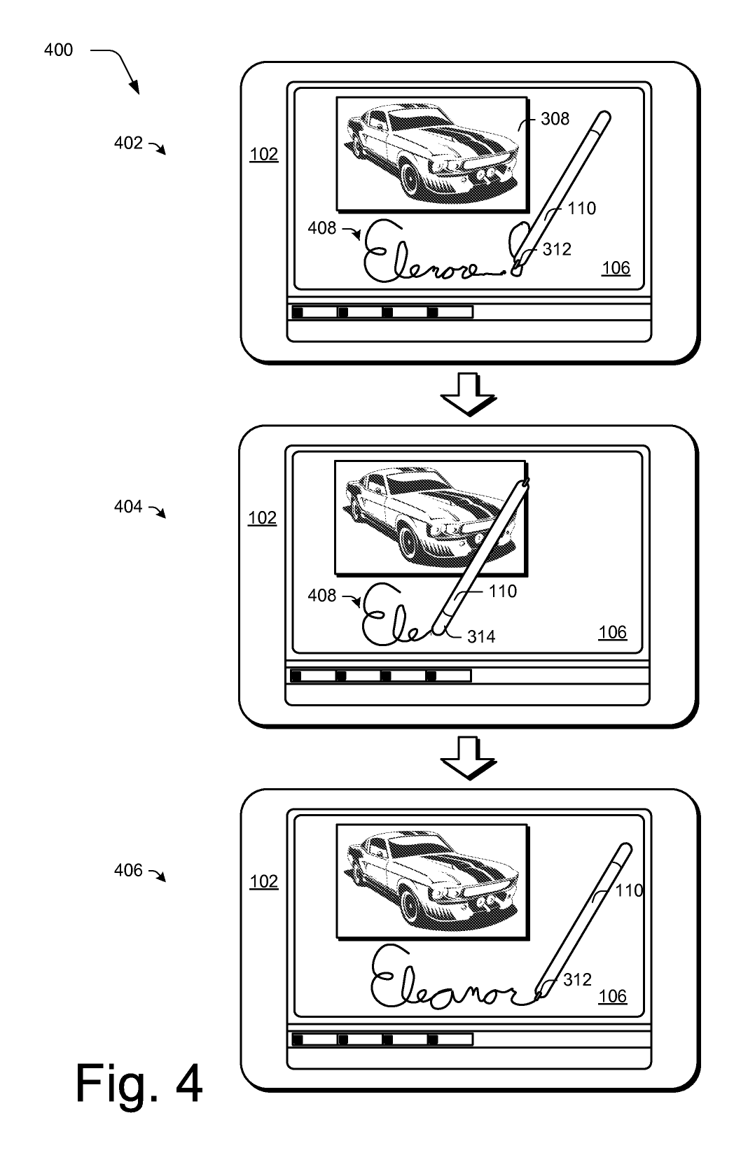

FIG. 4 depicts a system 400 in an example implementation in which an erase operation is performed having characteristics that correspond to a representation of a writing implement of a pencil chosen through interaction with the user interface of FIG. 2. The system 400 of FIG. 4 is illustrated as including first, second, and third stages 402, 404, 406.

Like FIG. 3, at the first stage 402 a photo 408 is illustrated as being displayed by the display device 106 of a car. A caption is also illustrated as freeform lines 408 that were handwritten using a first end 312 of the stylus 110. In this example the representation of the writing implement of a “pencil” was selected in FIG. 2 and therefore the freeform lines 408 are displayed to mimic strokes of a pencil.

At the second stage 404, the user may again realize that the caption composed of the freeform lines 408 is spelled incorrectly. Accordingly, a second end 314 of the stylus 110 may be utilized to indicate that an erase operation is to be performed to erase the freeform lines 408.

Because the representation of the pencil writing implement was selected, the erase operation is performed to have characteristics in accordance with a rubber eraser of pencil. Therefore, in this case portions of the freeform lines 408 over which the second end 314 of the stylus 110 was moved are deleted. In the illustrated instance in the second stage 404, the exclamation point and the letters “nore” shown in the first stage 402 are erased. Therefore, at the third stage 406 a user may correct the spelling using the original letters “Ele” and adding “anor” using the first end 312 of the stylus 110 to spell “Eleanor” as illustrated. Thus, the selection of the pencil representation may cause the erase operation to be employed to erase portions of the lines. Other examples are also contemplated, such as to mimic a lightening of penciled lines by a rubber eraser, an example of which is discussed in relation to the following figure.

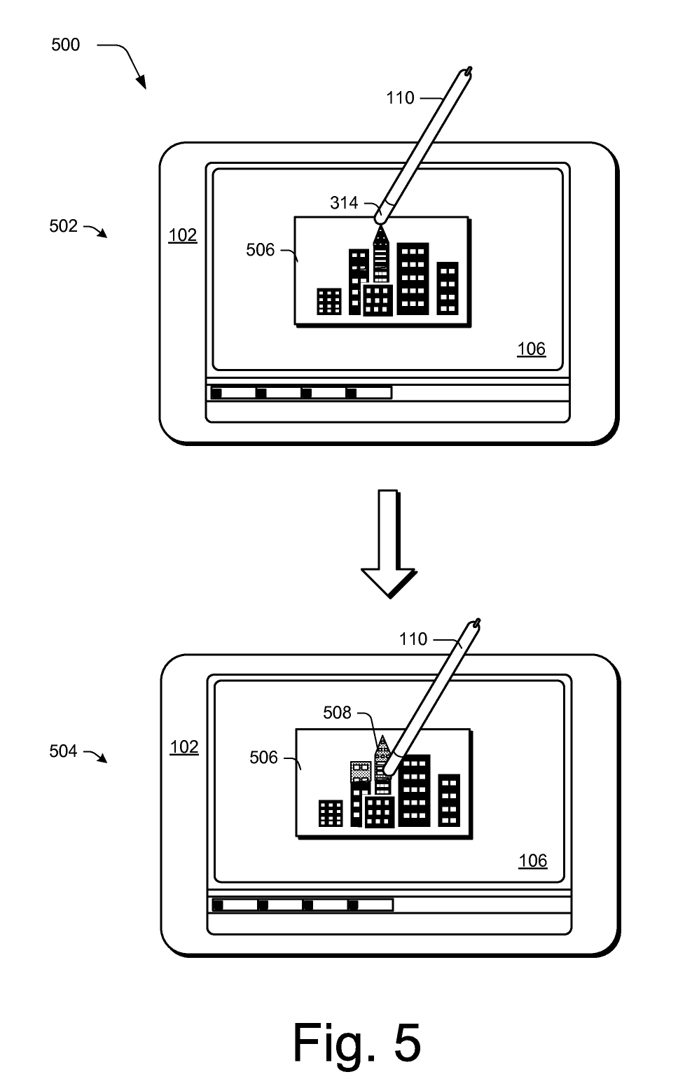

FIG. 5 depicts a system 500 in an example implementation in which another erase operation is performed having characteristics that correspond to a representation of a writing implement of a pencil chosen through interaction with the user interface of FIG. 2. The system 500 of FIG. 5 is illustrated as including first and second stages 502, 504.

At the first stage, an image 506 of a skyline is displayed on the display device 106 of the computing device 102. The image 506 may be configured in a variety of different ways, such as obtained through an image capture device (e.g., a camera), drawn using lines that are configured to mimic pencil lines, and so on. The stylus 110 is illustrated as initiating an erase operation by presenting the second end 314 of the stylus 110 for recognition by the computing device 102.

At the second stage 504, a result of the erase operation is displayed by the display device 106. The result in this instance is a lightening of an area 508 of the image 506 over which the second end 314 of the stylus 110 has been moved. Therefore, in this instance the erase operation is configured to mimic partial erasure of lines by lightening of the area 508 being erased, much like the application of a rubber eraser to sketched lines, e.g., lines made by a pencil, charcoal, and so on.

Although stylus inputs have been described in relation to FIGS. 3-5, it should be recognized that a variety of other inputs may leverage the techniques described herein. For example, a touch input may be used to different between drawing (e.g., through use of a tip of a finger, fingernail, and so on) and erase operations (e.g., through use of a pad of a finger, detection of a bottom of a fist made by the user's hand 108 when a representation of a dry erase writing implement is selected, and so on).

Example Procedures

The following discussion describes writing implement techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-500 of FIGS. 2-5.

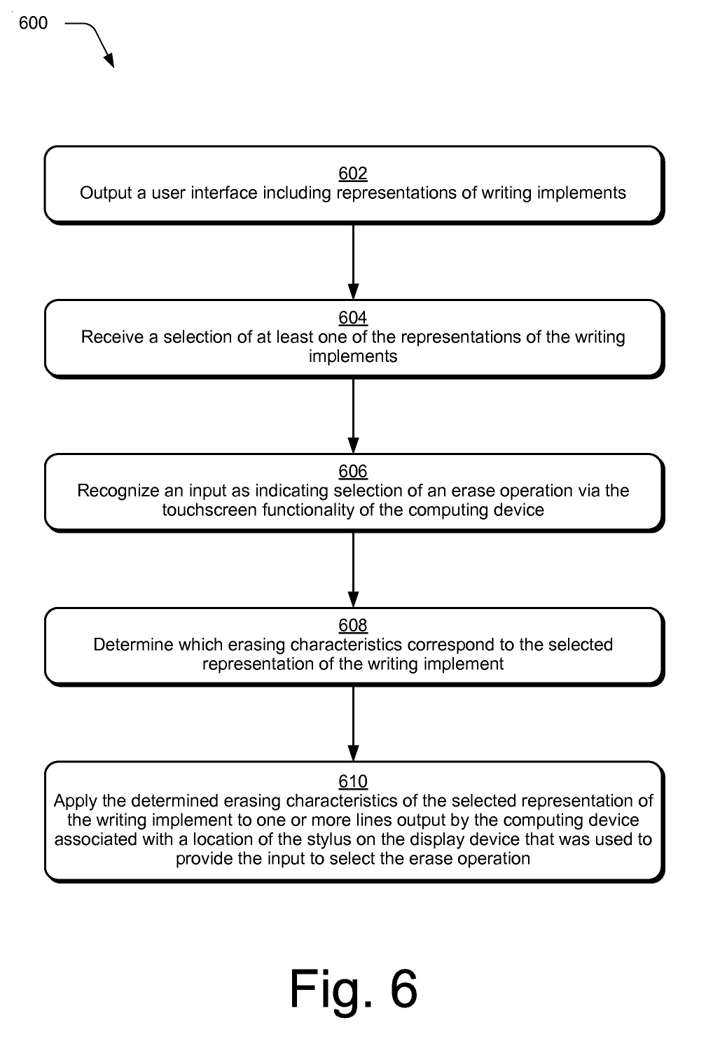

FIG. 6 depicts a procedure 600 in an example implementation in which selection of a writing implement is used as a basis to apply characteristics to an erase operation. A user interface is output that includes representations of writing implements (block 602). For example, the representations may describe a writing implement to be mimicked for both writing and erase operations (e.g., a pencil that is presumed to include a rubber eraser), separate out functionality of the writing implement (e.g., provide separate choices for writing operations and erase operations), and so on.

A selection is received of at least one of the representation of the writing implements (block 604). For example, a user may provide an input via a finger of the user's hand 108, the stylus 110, a cursor control device, and so on to select a representation displayed in the user interface 202.

An input is recognized as indicating selection of an erase operation via touchscreen functionality of the computing device (block 606). The erase operation, for instance, may be initiated by selecting an icon displayed by the display device, by using an end (e.g., the second end 314) of the stylus 110 that is to represent use of an eraser, and so on.

A determination is made as to which erasing characteristics correspond to the selected representation of the writing implement (block 608). The determination may be made in a variety of ways, such as responsive to the selection of the representation of the writing implement (e.g., block 604), responsive to the recognition of the input indicating selection of the erase operation (e.g., block 606), and so on.

The determined erasing characteristics of the selected representation of the writing implement are applied to one more lines output by the computing device associated with a location of the stylus on the display device that was used to provide the input to select the erase operation (block 610). As shown in FIG. 3, for instance, selection of a representation of a pen may cause a line and/or group of lines to be deleted as a whole, such as by “tapping” or “rubbing” the second end 314 of the stylus over the display of the freeform lines 308. In another example, selection of a representation of a pencil may cause a portion of a freeform line to be deleted by moving the second end 314 of the stylus over the display of the freeform lines 408, cause an area (e.g., having one or more lines) to be lightened as shown in FIG. 5, and so on. In this way, the characteristics of a writing implement may be mimicked by the computing device 102 to provide an intuitive user experience.

Example Device

FIG. 7 illustrates various components of an example device 700 that can be implemented as any type of portable and/or computer device as described with reference to FIGS. 1-5 to implement embodiments of the writing implement techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more o\f a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of a touch pull-in gesture. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the gesture techniques described herein. In this example, the device applications 718 include an interface application 722 and an input module 724 (which may be the same or different as input module 112) that are shown as software modules and/or computer applications. The input module 724 is representative of software that is used to provide an interface with a device configured to capture inputs, such as a touchscreen, track pad, camera, and so on. Alternatively or in addition, the interface application 722 and the input module 724 can be implemented as hardware, software, firmware, or any combination thereof. Additionally, the input module 724 may be configured to support multiple input devices, such as separate devices to capture touch and stylus inputs, respectively. For example, the device may be configured to include dual display devices, in which one of the display device is configured to capture touch inputs while the other stylus inputs.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented at least in part by a computing device, the method comprising:
outputting a user interface including representations of writing implements, one or more of the representations being associated with characteristics of the corresponding writing implement to be applied to:
lines detected as being drawn using touchscreen functionality of the computing device; and
lines detected as being erased using touchscreen functionality of the computing device; and
responsive to a selection of at least one of the representations, applying the corresponding characteristics to at least one input received via the touchscreen functionality.

2. A method as described in claim 1, wherein the at least one input is provided using a stylus or a user's hand.

3. A method as described in claim 1, wherein the computing device is configured to recognize a drawing operation initiated using a first end of a stylus and to recognize an erase operation using a second end of the stylus.

4. A method as described in claim 1, wherein the representations of the writing implements include a representation of a pencil and the characteristics that are associated with the pencil include progressively lightening one or more lines displayed by the computing device responsive to recognition of selection of an erase operation.

5. A method as described in claim 1, wherein the representations of the writing implements include a representation of a pencil and the characteristics that are associated with the pencil include progressively darkening one or more lines displayed by the computing device responsive to recognition of selection of a writing operation.

6. A method as described in claim 1, wherein the representations of the writing implements include a representation of a pen and the characteristics that are associated with the pen include deleting one or more lines displayed by the computing device responsive to recognition of selection of an erase operation.

7. A method as described in claim 6, wherein the one or more lines are recognized as being input within a threshold amount of time.

8. A method as described in claim 1, wherein the representations of the writing implements include a pencil representation and a pen representation.

9. A method as described in claim 1, wherein the representations of the writing implements include a marker representation, a highlighter representation, a dry erase marker, or a crayon representation.

10. A method implemented at least in part by a computing device, the method comprising:
recognizing an input as indicating initiation of an erase operation;
determining a characteristic of a writing implement selected to interact with the computing device using touchscreen functionality, the characteristic configured to mimic drawing and erasing characteristics of the writing implement; and
applying the erasing characteristics of the selected writing implement to one or more lines output by the computing device.

11. A method as described in claim 10, wherein the type of writing implement was selected by selecting one of a plurality of representations of writing implements in a user interface output by the computing device.

12. A method as described in claim 10, wherein the selected writing implement is a representation of a pencil and the characteristics that are associated with the pencil include progressively lightening one or more lines displayed by the computing device responsive to recognition of selection of the erase operation.

13. A method as described in claim 10, wherein the selected writing implement is a representation of a pencil and the characteristics that are associated with the pencil include progressively darkening an area of a user interface of the computing device responsive to recognition of selection of a writing operation.

14. A method as described in claim 10, wherein the selected writing implement is a representation of a pen and the characteristics that are associated with the pen include deleting one or more lines display by the computing device responsive to recognition of selection of the erase operation.

15. A method as described in claim 10, wherein the computing device is configured to recognize a drawing operation initiated using a first end of a stylus and to recognize an erase operation using a second end of the stylus.

16. One or more computer-readable media comprising instructions that, responsive to execution on a computing device, causes the computing device to perform operations comprising:
outputting a user interface including representations of writing implements;
receiving a selection of at least one of the representations of the writing implements;
recognizing an input as indicating selection of an erase operation via touchscreen functionality of the computing device, the input provided by a stylus using the touchscreen functionality of a display device;
determining which erasing characteristics correspond to the selected representation of the writing implement; and
applying the determined erasing characteristics of the selected representation of the writing implement to one or more lines output by the computing device associated with a location of the stylus on the display device that was used to provide the input to select the erase operation.

17. One or more computer-readable media as described in claim 16, wherein the representations of the writing implements include a representation of a pencil and the characteristics that are associated with the pencil include:
progressively lightening one or more lines displayed by the computing device responsive to recognition of selection of an erase operation; and
progressively darkening one or more lines displayed by the computing device responsive to recognition of selection of a writing operation.

18. One or more computer-readable media as described in claim 16, wherein the representations of the writing implements include a representation of a pen and the characteristics that are associated with the pen include deleting one or more lines displayed by the computing device responsive to recognition of selection of an erase operation.

19. One or more computer-readable media as described in claim 16, wherein the instructions cause the computing device to recognize a drawing operation initiated using a first end of a stylus and to recognize an erase operation using a second end of the stylus.

20. One or more computer-readable media as described in claim 16, wherein the representations of the writing implements include a marker representation, a highlighter representation, or a crayon representation.
